(19) United States
(12) Patent Application Publication
(10) Pub. No.: US 2025/0297865 A1
(43) Pub. Date: Sep. 25, 2025

(54) NAVIGATION APPARATUS

(71) Applicant: Honda Motor Co., Ltd., Tokyo (JP)

(72) Inventors: Sunao Yamaguchi, Tokyo (JP); Kaede Inoguchi, Tokyo (JP); Kaho Tonomura, Tokyo (JP)

(21) Appl. No.: 19/060,916

(22) Filed: Feb. 24, 2025

(30) Foreign Application Priority Data
Mar. 21, 2024 (JP) 2024-045223

(51) Int. Cl. G01C 21/36

(52) U.S. Cl. CPC G01C 21/3685

(57) ABSTRACT

A navigation apparatus includes a microprocessor communicatively connected to an input device and an output device. The microprocessor is configured to perform: acquiring position information indicating a current position of a vehicle; receiving an input of destination information indicating a destination and an input of purpose information indicating a purpose; referring to map information including road map information and facility information; temporarily setting a predetermined range including the destination as a first destination based on the destination information and the road map information; setting a specific position narrower than a range of the first destination as a second destination based on the purpose information and the facility information; setting a route based on the position information of the vehicle and a position information of the second destination; and outputting route guidance information based on the route and the position information of the vehicle.

### CROSS-REFERENCE TO RELATED APPLICATION

This application is based upon and claims the benefit of priority from Japanese Patent Application No. 2024-045223 filed on Mar. 21, 2024, the content of which is incorporated herein by reference.

### BACKGROUND

### Technical Field

The present invention relates to a navigation apparatus configured to provide route guidance.

### Related Art

As such a type of technology, for example, JP 2005-221285 A discloses a car navigation apparatus that displays a detailed destination image on a map so that a destination can be found without wandering even when route guidance ends near the destination.

However, in the technology described in JP 2005-221285 A, it is necessary for a user to estimate the destination by himself/herself by comparing the image with a landscape near the destination, and usability is poor for the user who is not used to driving. For example, in a parking lot attached to a large-scale facility such as a large shopping mall, it can be difficult to estimate which area in the parking lot to proceed based only on a displayed image of the parking lot, making it easy to get lost.

### SUMMARY

An aspect of the present invention is a navigation apparatus includes a microprocessor communicatively connected to an input device and an output device. The microprocessor is configured to perform: acquiring position information indicating a current position of a vehicle; receiving an input of destination information indicating a destination and an input of purpose information indicating a purpose; referring to map information including road map information and facility information regarding a facility and a parking lot; temporarily setting a predetermined range including the destination as a first destination based on the destination information and the road map information; setting a specific position narrower than a range of the first destination as a second destination based on the purpose information and the facility information; setting a route based on the position information of the vehicle and a position information of the second destination; and outputting route guidance information based on the route and the position information of the vehicle.

### BRIEF DESCRIPTION OF DRAWINGS

The objects, features, and advantages of the present invention will become clearer from the following description of embodiments in relation to the attached drawings, in which:

FIG. 1 is a schematic diagram illustrating an example of an IVI system including a navigation apparatus;

FIG. 2 is a diagram illustrating an operation menu screen;

FIG. 3A is a block diagram illustrating a configuration of a main part of the navigation apparatus;

FIG. 3B is a block diagram illustrating a configuration of a main part of a terminal;

FIG. 3C is a block diagram illustrating a configuration of a main part of a vehicle sensor group and a vehicle cabin camera;

FIG. 3D is a block diagram illustrating a configuration of a main part of an input device and an output device; and

FIG. 4 is a flowchart for describing an example of control processing by a program.

### DETAILED DESCRIPTION OF THE INVENTION

An embodiment of the invention will be described below with reference to the drawings.

### Outline of Navigation Apparatus

A navigation apparatus searches for an appropriate traveling route from a current position to a destination, and provides route guidance to a user along the traveling route. That is, the navigation apparatus has a setting function of setting the destination or the like, a search function of searching for the traveling route that meets a search condition such as whether or not to use a toll road, and an output function of outputting guidance information along the searched route.

Particularly, the navigation apparatus according to the embodiment has a characteristic related to destination setting. Specifically, the destination of the route guidance is set by two-stage input operations. For example, the navigation apparatus temporarily sets, as a first destination, a predetermined range based on the first input operation from the user, and presents a plurality of purpose candidates associated in advance with facilities existing in the first destination to the user. The purpose candidate is a purpose for the user to move to the destination, and for example, “eating meat”, “buying shoes”, “picking someone up”, “seeing someone off”, “event”, and the like are presented.

When one of the plurality of presented purpose candidates is selected by the second input operation from the user, the navigation apparatus sets, as a second destination, a specific position matching the selected purpose candidate. As the specific position, for example, a “steak restaurant” is set for the purpose of “eating meat”, a “shoe shop” is set for the purpose of “buying shoes”, an “arrival terminal” is set for the purpose of “picking someone up”, a “departure terminal” is set for the purpose of “seeing someone off”, and a position such as an “event space” is set for the purpose of “event”.

As described above, the navigation apparatus according to the embodiment sets the destination of the route guidance in consideration of the purpose of the user so that the user can arrive without wandering.

In the embodiment, the navigation apparatus is provided as one of functions of an in-vehicle infotainment (IVI) system provided in a vehicle. The setting of the destination in the navigation apparatus will be described in more detail.

### System Configuration Example

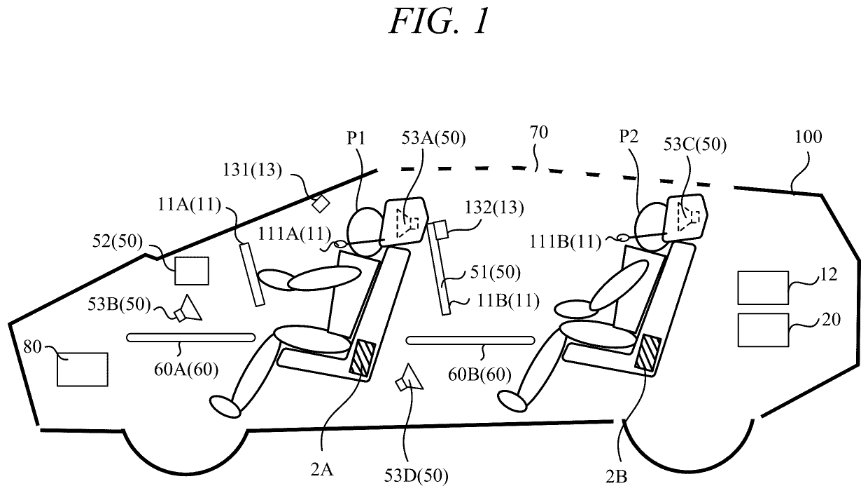

FIG. 1 is a schematic diagram illustrating an example of the IVI system including the navigation apparatus. The IVI system includes a control apparatus 20, a vehicle sensor group 12 of a vehicle 100 serving as a moving body, a display unit 51, a projection unit 52, and voice reproducing units 53A to 53D included in an output device 50 provided in the vehicle 100, operation detection units 11A and 11B and microphones 111A and 111B included in an input device 11 provided in the vehicle 100, a front seat camera 131 and a rear seat camera 132 included in a vehicle cabin camera 13 provided in the vehicle 100, a terminal 2A used by an occupant P1 in a front seat of a cabin, and a terminal 2B used by an occupant P2 in a rear seat of the cabin.

The control apparatus 20 and the terminals 2A and 2B are configured to be capable of wireless communication. The control apparatus 20, the output device 50, the input device 11, the vehicle sensor group 12, and the vehicle cabin camera 13 are configured to be capable of wired communication using a controller area network (CAN) or the like.

The vehicle 100 includes an air-conditioning device 80 that adjusts temperature and humidity in the cabin, a lighting device 70 (which may also be referred to as a dimmable sunroof) that can adjust a lighting amount for the inside of the cabin by using dimmable glass covering substantially the entire ceiling of the cabin, and an ambient light 60A for the front seat and an ambient light 60B for the rear seat included in an illumination device 60.

As an example, the terminals 2A and 2B are implemented by smartphones or the like used by the occupants P1 and P2, respectively. Each of the terminals 2A and 2B may be held by a holder (not illustrated) installed on a seat on which each person is seated.

Although the two terminals 2A and 2B are illustrated as terminals used by the occupants P1 and P2, the actual number of terminals varies depending on the number of occupants. The number of terminals is four in a case where there are four occupants. In addition, the number of cameras in the vehicle cabin camera 13, the number of operation detection units and the number of microphones in the input device 11, and the number of display units, the number of projection units, and the number of voice reproducing units in the output device 50 may also appropriately vary depending on the number of occupants.

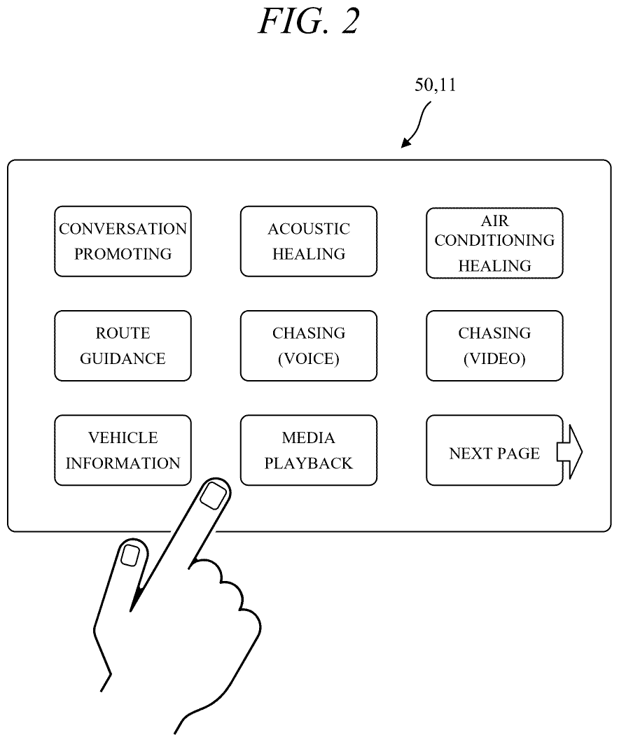

FIG. 2 is a diagram illustrating an operation menu screen of the IVI system of FIG. 1. In the embodiment, the operation menu screen is projected or displayed on the output device 50 (the projection unit 52 or the display unit 51). When a menu button (which may be referred to as an icon) displayed on the output device 50 is touched or a voice corresponding to the menu button is input from the microphones 111A and 111B included in the input device 11, the control apparatus 20 starts an operation of a function corresponding to the menu for which the touch operation has been made or the voice has been input.

The operation menu screen illustrated in FIG. 2 includes menu buttons corresponding to a “conversation promoting” function of supporting a conversation between the occupants of the vehicle 100, a “acoustic healing” function of soothing the occupants by reproduced sounds of the voice reproducing units 53A to 53D, an “air conditioning healing” function of soothing the occupants by using the air-conditioning device 80, a “route guidance” function of guiding a traveling route to a destination, a “chasing (voice)” function of connecting the terminal of the occupant who gets off the vehicle 100 and a communication unit (described below) of the control apparatus 20 to transmit an external voice to the occupant in the cabin, a “chasing (video)” function of connecting the terminal of the occupant who gets off the vehicle 100 and the communication unit (described below) of the control apparatus 20 to transmit an external video to the occupant in the cabin, a “vehicle information” function of performing function setting of the vehicle 100, an auxiliary machine operation, and the like, a “media playback” function of reproducing a medium in which a content is recorded from the output device 50, and other functions (not described).

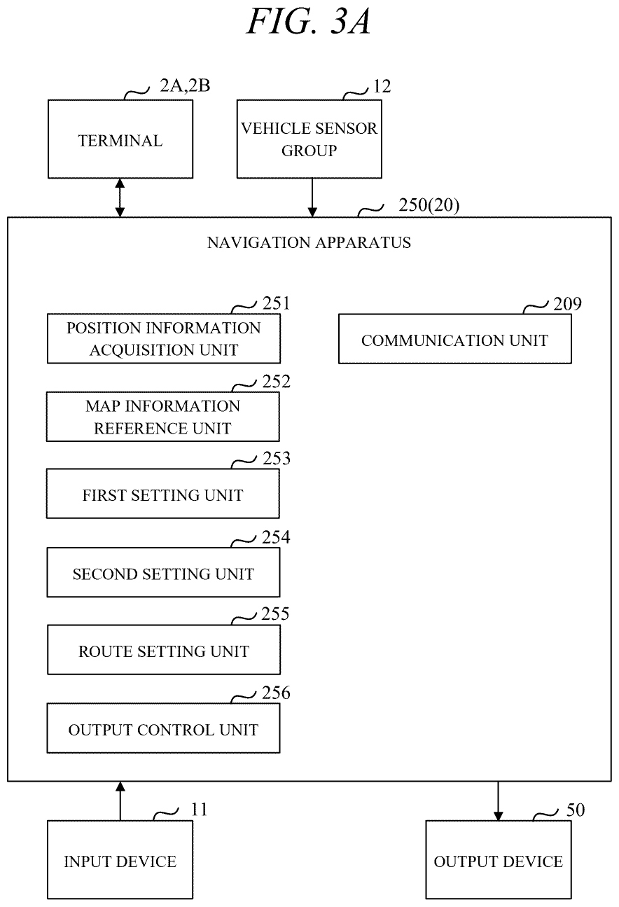

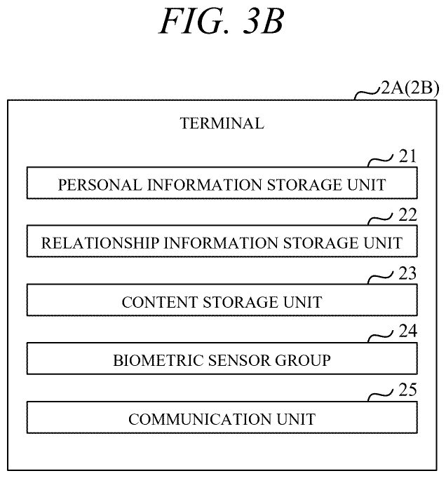

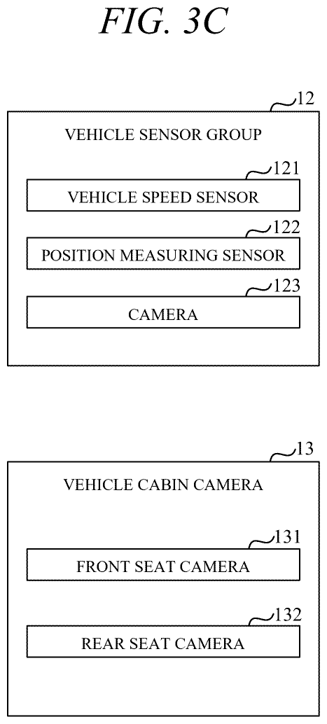

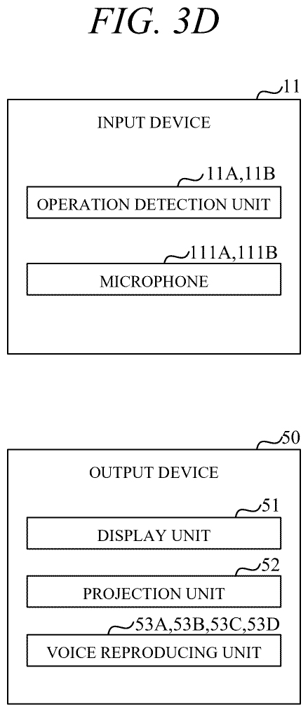

Hereinafter, among functions of the control apparatus 20 as the navigation apparatus in a case where the “route guidance” button on the operation menu screen is operated, destination setting will be mainly described. FIGS. 3A to 3D are diagrams for describing a configuration example of each unit in FIG. 1.

### Navigation Apparatus

FIG. 3A is a block diagram illustrating a configuration of a main part of the control apparatus 20. The control apparatus 20 includes an arithmetic processing unit such as a micro processing unit (MPU) (not illustrated) and reads and executes a predetermined program stored in a storage unit (not illustrated) to perform various types of information processing, control processing, and the like necessary for the control apparatus 20.

The control apparatus 20 includes, as a functional configuration for a navigation apparatus 250, a position information acquisition unit 251, a map information reference unit 252, a first setting unit 253, a second setting unit 254, a route setting unit 255, an output control unit 256, and a communication unit 209, and controls the IVI system to function as the navigation apparatus 250.

### Position Information Acquisition Unit

The position information acquisition unit 251 acquires current position information of the vehicle 100 based on a signal from a position measuring sensor 122 included in the vehicle sensor group 12.

### Map Information Reference Unit

The map information reference unit 252 refers to map information including road map information and facility information including a facility and a parking lot. The map information reference unit 252 may refer to the map information stored in a storage unit of the control apparatus 20, or may refer to the map information stored in an external content management server via a communication network (not illustrated).

### First Setting Unit

The first setting unit 253 temporarily sets a predetermined range including the destination as the first destination based on destination information input from the occupant P1 or P2 and a road map (included in the map information as the road map information) referred to by the map information reference unit 252.

The destination information is information indicating the destination, and may be a name of a region, a location (a town name, a lot number, or the like), or a name of a facility. In the embodiment, as an example, voice signals are input from the microphones 111A and 111B included in the input device 11.

The first setting unit 253 receives an input operation for the destination by voices of the occupants P1 and P2 by using, for example, technologies such as voice recognition or natural language processing based on the input voice signals.

When the first setting unit 253 recognizes the destination such as “AA hill”, “block B in AA town”, “CC shopping mall”, or “AA airport”, for example, the first setting unit 253 temporarily sets, as the first destination, a predetermined range including a plurality of facilities existing in the vicinity of the recognized destination such as “the vicinity of AA hill”, “the vicinity of block B in AA town”, “the vicinity of CC shopping mall”, or “the vicinity of AA airport” based on the road map referred to above. The reason for the temporary setting is that narrowing down is performed using purpose information input next from the occupant P1 or P2.

### Second Setting Unit

The second setting unit 254 sets a specific position narrower than the range of the first destination as the second destination based on the purpose information input from the occupant P1 or P2 and the facility information (included in the map information) referred to by the map information reference unit 252.

The purpose information is information indicating the purpose for which the occupant P1 or P2 moves in the vehicle 100, and is “eating meat”, “buying shoes”, “picking someone up”, “seeing someone off”, “event”, or the like exemplified above. When the first destination temporality set by the first setting unit 253 is temporality set, the second setting unit 254 presents, as an example, the plurality of purpose candidates associated in advance with each of the plurality of facilities (recorded in the facility information) existing in the first destination to the display unit (the projection unit 52 or the display unit 51) included in the output device 50. For example, in a case where there are a plurality of facilities (the “steak restaurant”, the “shoe shop”, the “arrival terminal”, the “departure terminal”, and the “event space” exemplified above) in “the vicinity of AA airport” as the first destination, the purpose candidate associated with each facility in advance is presented. In the embodiment, the purpose candidates corresponding to the exemplified “steak restaurant”, “shoe shop”, “arrival terminal”, “departure terminal”, and “event space” are “eating meat”, “buying shoes”, “picking someone up”, “seeing someone off”, and “event”, respectively.

That is, when the occupant P1 or P2 inputs the destination “AA airport”, the first setting unit 253 temporarily sets “the vicinity of AA airport” as the first destination, and the second setting unit 254 presents the purpose candidates (here, “eating meat”, “buying shoes”, “picking someone up”, “seeing someone off”, and “event”) associated with the plurality of facilities existing in the vicinity of the first destination to the occupant P1 or P2 via the display unit (the projection unit 52 and the display unit 51) serving as the output device 50.

As an example, the second setting unit 254 inputs a signal for selecting one of the plurality of purpose candidates as the purpose information from the operation detection units 11A and 11B included in the input device 11, and sets a specific position matching the input purpose information as the second destination. In the above example, a position of the “steak restaurant” is set as the second destination for the purpose information of “eating meat”, a position of the “shoe shop” is set as the second destination for the purpose information of “buying shoes”, a position of the “arrival terminal” is set as the second destination for the purpose information of “picking someone up”, a position of the “departure terminal” is set as the second destination for the purpose information of “seeing someone off”, and a position of the “event space” is set as the second destination for the purpose information of “event”.

When presenting the plurality of purpose candidates associated in advance with each facility to the occupant P1 or P2 via the output device 50, the second setting unit 254 may present a purpose candidate list in which the purpose candidates are described according to a predetermined priority for each facility to the output device 50 as image information.

When determining the priority, the second setting unit 254 may determine the priority based on certainty. For example, when the first destination is “the vicinity of CC station”, the order is determined such that “meeting”, “seeing someone off”, and “picking someone up”, which are highly related to a station, are ranked higher than “eating BB”, “buying DD”, and “event” as the purpose candidates.

In addition, the second setting unit 254 may determine the priorities of the plurality of purpose candidates by using a weight value based on at least one of the number of times of selection of the purpose candidate by the occupant P1 or P2 in the past, a day of the week selected by the occupant P1 or P2 in the past, and a time zone selected by the occupant P1 or P2 in the past.

### Route Setting Unit

The route setting unit 255 searches for and sets an appropriate route based on the current position information of the vehicle 100 acquired by the position information acquisition unit 251, position information of the second destination set by the second setting unit 254, the search condition (for example, whether or not to travel on a toll road or whether or not to travel mainly on a highway) separately set by the occupant P1 or P2, and the map information.

In addition, the route setting unit 255 appropriately searches for a route even during the traveling of the vehicle 100 by, for example, searching for a detour route based on new information such as congestion information, or searching for a new traveling route when the current position of the vehicle 100 deviates from the traveling route being guided.

### Output Control Unit

The output control unit 256 outputs route guidance information based on the route set by the route setting unit 255 to the output device 50. As a result, a map screen showing the traveling route is displayed or projected via the display unit 51 or the projection unit 52, and audio guides are reproduced from the voice reproducing units 53A to 53D.

Communication Unit The communication unit 209 includes a short-range wireless communication module (not illustrated) that performs wireless communication with the terminals 2A and 2B and a wired communication module (not illustrated) that performs wired communication by the CAN or the like. A wireless communication system having a direction sensing function may be adopted as the short-range wireless communication module

### Terminal

FIG. 3B is a block diagram illustrating a configuration of a main part of the terminal 2A. Since a configuration of the terminal 2B is similar to that of the terminal 2A, illustration thereof is omitted. The terminal 2A includes an arithmetic processing unit such as an MPU (not illustrated), and reads and executes a predetermined program (which may also be referred to as an application) stored in a storage unit (not illustrated) to perform various types of information processing, control processing, and the like necessary for a functional configuration described below.

The terminal 2A includes, as the functional configuration, a personal information storage unit 21, a relationship information storage unit 22, a content storage unit 23, a biometric sensor group 24, and a communication unit 25. In general, a smartphone includes a display unit, an input unit, a voice reproducing unit, a camera, a position detection unit, and the like, but illustration and description thereof are omitted.

The terminal 2A may share a function with another device such as a smart watch (not illustrated).

### Personal Information Storage Unit

The personal information storage unit 21 stores personal information of the occupant P1 who possesses the terminal 2A. In a case where the IVI system functions as the navigation apparatus 250, the personal information is not necessary.

### Relationship Information Storage Unit

The relationship information storage unit 22 stores relationship level information of the occupant P1 using the terminal 2A. In a case where the relationship level information indicating the degree of intimacy between the occupants P1 and P2 in the cabin is transmitted from the control apparatus 20, the relationship information storage unit 22 stores the relationship level information. In a case where the IVI system functions as the navigation apparatus 250, the relationship level information is not necessary.

Content Storage Unit The content storage unit 23 stores a content collected by the occupant P1 who possesses the terminal 2A or information (for example, a cloud storage that stores a content or a URL of a server that streams and reproduces a content) necessary for reproducing a content. For example, a sound content that the occupant P1 wants to listen to at the time of feeling fatigue may be stored in the content storage unit 23 in advance. The sound content includes a voice content and a music content.

### Biometric Sensor Group

The biometric sensor group 24 includes, for example, a heart rate sensor that acquires a heart rate of the occupant P1 who possesses the terminal 2A, a respiration sensor that acquires a respiration rate, a blood flow rate sensor that acquires a blood flow rate, and a skin electrical resistance sensor that acquires a skin electrical resistance value (all the sensors described above are not illustrated). In a case where the IVI system functions as the navigation apparatus 250, biological information of the occupant P1 collected by the biometric sensor group 24 is not necessary.

### Communication Unit

The communication unit 25 includes a short-range wireless communication module (not illustrated) that performs wireless communication with the control apparatus 20 and a wired communication module (not illustrated) that performs wired communication by the CAN or the like.

FIG. 3C is a block diagram illustrating configurations of main parts of the vehicle sensor group 12 and the vehicle cabin camera 13 of the vehicle 100.

### Vehicle Sensor Group

The vehicle sensor group 12 includes a vehicle speed sensor 121, a position measuring sensor 122, and a camera 123. In general, an acceleration sensor, a radar, and the like are mounted as sensors on the vehicle 100, but illustration and description thereof are omitted.

Vehicle Speed Sensor The vehicle speed sensor 121 detects a vehicle speed of the vehicle 100 and outputs vehicle speed information to the control apparatus 20. In a case where the IVI system functions as the navigation apparatus 250, the vehicle speed information can be used to calculate the estimated time of arrival at the destination.

### Position Measuring Sensor

The position measuring sensor 122 detects a current position of the vehicle 100 based on a positioning signal from a global positioning system (GPS) satellite, a quasi-zenith satellite, or the like. The position measuring sensor 122 outputs a signal indicating the current position to the control apparatus 20 as position information. In a case where the IVI system functions as the navigation apparatus 250, the information regarding the current position can be used to calculate the estimated time of arrival at the destination.

### Camera

The camera 123 images the surroundings of the vehicle 100. The camera 123 outputs data of a subject image to the control apparatus 20 as image information. The camera 123 can capture still images and videos. In a case where the IVI system functions as the navigation apparatus 250, the image information of the surroundings of the vehicle 100 is not necessary.

### Vehicle Cabin Camera

The vehicle cabin camera 13 includes the front seat camera 131 and the rear seat camera 132. The front seat camera 131 images the upper body of the occupant P1 seated in the front seat, and outputs data of the subject image to the control apparatus 20 as the image information. The rear seat camera 132 images the upper body of the occupant P2 seated in the rear seat, and outputs data of the subject image to the control apparatus 20 as the image information.

FIG. 3D is a block diagram illustrating configurations of main parts of the input device 11 and the output device 50 of the vehicle 100.

### Input Device

The input device 11 includes the operation detection units 11A and 11B and the microphones 111A and 111B.

### Operation Detection Unit

The operation detection unit 11A is operated by the occupant P1 in the front seat, and outputs an operation signal to the control apparatus 20. The operation detection unit 11A may be implemented as a pointing device that is operated in conjunction with the projected image projected by the projection unit 52 described below. The operation detection unit 11B is provided on a display surface of the display unit 51. The operation detection unit 11B is operated by the occupant P2 in the rear seat and outputs an operation signal indicating a touch position to the control apparatus 20.

### Microphone

The microphone 111A collects the voice uttered by the occupant P1 in the front seat and outputs the voice signal to the control apparatus 20. The microphone 111B collects the voice uttered by the occupant P2 in the rear seat and outputs the voice signal to the control apparatus 20.

### Output Device

The output device 50 includes the display unit 51, the projection unit 52, and the voice reproducing units 53. The output device 50 is used, for example, for displaying the operation menu screen of FIG. 2, presenting the purpose candidate list when performing the destination setting in the navigation apparatus 250, outputting the route guidance information of the navigation apparatus 250, reproducing a content, and the like.

The purpose candidate list is presented as the image information from the second setting unit 254 described above.

The route guidance information is guidance information based on the route set by the route setting unit 255 described above, and is output from the output control unit 256 described above.

The content to be reproduced may be acquired from the terminals 2A and 2B possessed by the plurality of occupants P1 and P2 in the cabin via the communication unit 209. The content may be acquired not only from the terminals 2A and 2B but also from an external content management server via a communication network (not illustrated). The content management server includes a cloud storage that stores a content and a streaming server that reproduces a content. The content to be reproduced is searched and acquired by the control apparatus 20 via the communication unit 209.

Note that the content to be reproduced may be a video content (a moving image, a still image, text display, icon display, graphic display, or the like) or a sound content.

### Display Unit

The display unit 51 includes a screen such as a liquid crystal display, and displays the image information based on a display signal output from the control apparatus 20. The image information includes the operation menu screen of FIG. 2, the purpose candidate list presented from the second setting unit 254, the map screen of the route guidance information, an image of the video content, and the like.

### Projection Unit

The projection unit 52 is implemented by, for example, a head-up display (HUD) to be projected on a windshield or the like, and projects the image information based on a projection signal output from the control apparatus 20. The image information includes the operation menu screen of FIG. 2, the purpose candidate list presented from the second setting unit 254, the map screen of the route guidance information, an image of the video content, and the like.

### Voice Reproducing Unit

The voice reproducing units 53A to 53D are implemented as speakers that reproduce and output the voice and the like, and reproduce the audio guide of the route guidance information, the sound content, and the like based on a reproduction signal output from the control apparatus 20. Note that a sound output unit that outputs a content reproduction signal to a headphone (not illustrated) or the like may be provided.

### Description of Flowchart

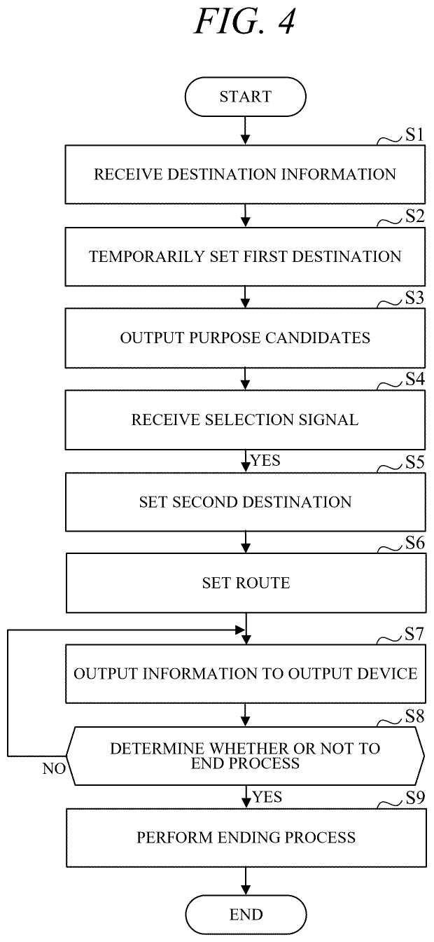

FIG. 4 is a flowchart for describing an example of control processing by the program executed by the MPU of the control apparatus 20. When the “route guidance” button is operated on the operation menu screen of FIG. 2, the MPU of the control apparatus 20 executes a program for performing the processing illustrated in FIG. 4 in order to cause the IVI system to function as the navigation apparatus 250. The control apparatus 20 functions as a control unit of the navigation apparatus 250 during execution of the program.

In step S1 of FIG. 4, the control apparatus 20 causes the input device 11 to receive the destination information input from the occupant P1 or P2, and proceeds to step S2.

In step S2, the control apparatus 20 causes the first setting unit 253 to temporarily set the first destination, and proceeds to step S3.

In step S3, the control apparatus 20 causes the second setting unit 254 to output (or present) the purpose candidates via the output device 50, and proceeds to step S4.

In step S4, the control apparatus 20 causes the input device 11 to receive a selection signal input from the occupant P1 or P2, and proceeds to step S5.

In step S5, the control apparatus 20 causes the second setting unit 254 to set the second destination, and proceeds to step S6.

In step S6, the control apparatus 20 causes the route setting unit 255 to set the route, and proceeds to step S7.

In step S7, the control apparatus 20 causes the output control unit 256 to output the route guidance information, and proceeds to step S8.

In step S8, the control apparatus 20 determines whether or not to end the control processing. In a case where a predetermined end operation is performed, the control apparatus 20 makes an affirmative determination in step S8 and proceeds to step S9, and in a case where the end operation is not performed, the control apparatus 20 makes a negative determination in step S8 and returns to step S7. In the case of returning to step S7, the control apparatus 20 repeats the above-described processing. That is, the output of the route guidance information is continued.

In step S9, the control apparatus 20 performs end processing and ends the processing of FIG. 4. The end processing includes the end of the outputting of the route guidance information by the output control unit 256 and the end of the route searching by the route setting unit 255.

According to the embodiment described above, the following effects are obtained.
(1) The navigation apparatus 250 of the vehicle 100 includes: the position information acquisition unit 251 that acquires the position information of the vehicle 100; the input device 11 serving as an input unit that receives the destination information indicating the destination and further receives the purpose information indicating the purpose; the map information reference unit 252 that refers to the map information including the road map information and the facility information including the facility and the parking lot; the first setting unit 253 that temporarily sets a predetermined range including the destination as the first destination based on the destination information and the road map information referred to by the map information reference unit 252; the second setting unit 254 that sets a specific position narrower than the range of the first destination as the second destination based on the purpose information and the facility information referred to by the map information reference unit 252; the route setting unit 255 that sets the route based on the position information of the vehicle 100 acquired by the position information acquisition unit 251 and the position information of the second destination; and the output control unit 256 serving as an output unit that outputs the route guidance information based on the set route and the position information of the vehicle 100.

With such a configuration, it is possible to set the destination so as to arrive without wandering. For example, also for a destination such as a parking lot attached to a large-scale facility, it is possible to set the second destination in a narrower range than “the vicinity of the parking lot” according to the related art. As a result, even after the vehicle 100 reaches “the vicinity of the parking lot”, the route guidance information is provided until the vehicle 100 reaches the second destination. The user can concentrate on driving and arrive at the second destination without getting lost in the parking lot.
(2) In the navigation apparatus 250, when the first destination is temporarily set by the first setting unit 253, the second setting unit 254 outputs the plurality of purpose candidates associated in advance with the facilities existing in the first destination to the output control unit 256, the input device 11 inputs a signal for selecting one of the plurality of purpose candidates as the destination information, and the second setting unit 254 sets a specific position matching the selected purpose candidate as the second destination.

With such a configuration, the user can easily select the purpose information from among the purpose candidates related to the plurality of facilities existing in the first destination temporarily set based on the destination information input by the user. The second setting unit 254 can set, as the second destination, a position (specific position) convenient for accessing a facility suitable for the purpose of the user.
(3) In the navigation apparatus 250, the second setting unit 254 outputs the plurality of purpose candidates associated in advance with the respective facilities to the output control unit 256 according to a priority determined in advance for each facility.

With such a configuration, it is possible to present the purpose candidates related to the plurality of facilities existing in the first destination to the user, for example, in descending order of probability of being suitable for the purpose of the user. Therefore, usability is improved for the user as compared with a case where the purpose candidates are randomly presented.
(4) In the navigation apparatus 250, the priorities of the plurality of purpose candidates are determined by using the weight value based on at least one of the number of times of selection in the past, the day of the week selected in the past, and the time zone selected in the past.

With such a configuration, it is possible to present the purpose candidates related to the plurality of facilities existing in the first destination to the user in order of higher probability of being suitable for the purpose of the user. That is, by increasing the weight value of the purpose candidate selected in the past by the user, the purpose candidates can be presented in an order in which the past selection content is reflected. Therefore, the usability is further improved for the user as compared with a case where the purpose candidates are randomly presented.

The above embodiment can be modified in various manners. Hereinafter, modified examples will be described.

### First Modified Example

In the above embodiment, an example in which four persons including the driver are in the cabin has been described, but the number of occupants is not limited to four, and may be one or plural.

### Second Modified Example

In the embodiment and the first modified example described above, the vehicle 100 serving as the moving body has been exemplified, but a conveyance in a form different from the vehicle 100 may be used as long as the conveyance is a moving body.

The above embodiment can be combined as desired with one or more of the above modifications. The modifications can also be combined with one another.

According to the present invention, it is possible to set a destination so as to arrive without wandering.

Above, while the present invention has been described with reference to the preferred embodiments thereof, it will be understood, by those skilled in the art, that various changes and modifications may be made thereto without departing from the scope of the appended claims.

What is claimed is:

1. A navigation apparatus comprising
a microprocessor communicatively connected to an input device and an output device, wherein
the microprocessor is configured to perform:
acquiring position information indicating a current position of a vehicle;
receiving an input of destination information indicating a destination and an input of purpose information indicating a purpose;
referring to map information including road map information and facility information regarding a facility and a parking lot;
temporarily setting a predetermined range including the destination as a first destination based on the destination information and the road map information;
setting a specific position narrower than a range of the first destination as a second destination based on the purpose information and the facility information;
setting a route based on the position information of the vehicle and position information of the second destination; and
outputting route guidance information based on the route and the position information of the vehicle.

2. The navigation apparatus according to claim 1, wherein
the microprocessor is configured to perform
the setting of the second destination including, when the first destination is temporarily set, outputting a plurality of purpose candidates associated in advance with the facility existing in the first destination to the output device, inputting a signal for selecting one of the plurality of purpose candidates as the destination information via the input device, and setting the specific position matching one purpose candidate as the second destination.

3. The navigation apparatus according to claim 2, wherein
the microprocessor is configured to perform
the setting of the second destination including outputting the plurality of purpose candidates associated in advance with the facility, to the output device according to a priority determined in advance for the facility.

4. The navigation apparatus according to claim 3, wherein
the priorities of the plurality of purpose candidates are determined by using a weight value based on at least one of a number of times of selection in a past, a day of a week selected in the past, and a time zone selected in the past.

5. The navigation apparatus according to claim 3, wherein
the priorities of the plurality of purpose candidates are determined such that a purpose candidate having a higher relevance to the facility is given higher priority.
